(19) United States
(12) Patent Application Publication
(10) Pub. No.: US 2026/0081136 A1
(43) Pub. Date: Mar. 19, 2026

(54) ELECTROCHEMICAL DEPOSITION OF METAL OXIDE COATING ON CATHODE ACTIVE MATERIALS

(71) Applicant: GM GLOBAL TECHNOLOGY OPERATIONS LLC, DETROIT, MI (US)

(72) Inventors: Jeffrey David Cain, Royal Oak, MI (US); Sayed Youssef Sayed Nagy, Troy, MI (US); Devendrasinh Darbar, Sterling Heights, MI (US)

(21) Appl. No.: 18/887,421

(22) Filed: Sep. 17, 2024

(51) Int. Cl. H01M 4/04; H01M 4/02; H01M 4/48

(52) U.S. Cl. CPC H01M 4/045; H01M 4/48; H01M 2004/021; H01M 2004/028

(57) ABSTRACT

Aspects of the disclosure include the electrochemical deposition of a metal oxide coating on cathode active materials and resulting battery cells. An exemplary vehicle includes an electric motor and a battery pack electrically coupled to the electric motor. The battery pack includes a battery cell that includes an anode current collector, an anode active material layer in direct contact with a surface of the anode current collector, a cathode current collector, a cathode active material layer in direct contact with a surface of the cathode current collector, and a separator positioned between the anode active material layer and the cathode active material layer. The cathode active material layer includes cathode active materials having a metal oxide coating. The metal oxide coating is electrochemically deposited onto the cathode active materials.

### INTRODUCTION

The present disclosure relates to battery cell manufacturing, and particularly to the electrochemical deposition of a metal oxide coating on cathode active materials.

Lithium-ion batteries, also known as lithium-ion cells, are a type of rechargeable battery technology that have gained significant attention due to their relatively high energy density and long cycle life compared to other battery chemistries. The anode (negative electrode) in a lithium-ion cell is typically made of graphite, a carbon-based material that can reversibly intercalate and deintercalate lithium ions. The cathode (positive electrode) can be made of various lithium-containing compounds, such as lithium transition metal oxides (e.g., LiCoO₂, LiNiMnCoO₂, etc.), lithium metal phosphates (e.g., LiFePO₄), or other suitable materials that can reversibly intercalate and deintercalate lithium ions.

The electrodes in a lithium-ion cell are separated by an electrolyte, which is typically a lithium salt dissolved in an organic solvent, a solid polymer or solid-state electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium ions deintercalate from the anode and migrate through the electrolyte to intercalate into the cathode material, while electrons flow through the external circuit to power a device. During charging, this process is reversed, with lithium ions being extracted from the cathode and intercalated back into the anode.

### SUMMARY

In one exemplary embodiment a vehicle includes an electric motor and a battery pack electrically coupled to the electric motor. The battery pack includes a battery cell that includes an anode current collector, an anode active material layer in direct contact with a surface of the anode current collector, the anode active material layer including anode active materials, and, optionally, an anode binder, electrically conductive material, or both the anode binder and the electrically conductive material, a cathode current collector, a cathode active material layer in direct contact with a surface of the cathode current collector, the cathode active material layer including cathode active materials having a metal oxide coating, and, optionally, a cathode binder, electrically conductive material, or both the cathode binder and the electrically conductive material, and a separator positioned between the anode active material layer and the cathode active material layer. The metal oxide coating is electrochemically deposited onto the cathode active materials.

In addition to one or more of the features described herein, in some embodiments, the metal oxide coating is of the form MO₂, where M is titanium, manganese, aluminum, zirconium, zinc, copper, or magnesium.

In some embodiments, the metal oxide coating is TiO₂.

In some embodiments, a surface of the metal oxide coating includes a thickness variation of between 5 nm and 10 nm. In some embodiments, a nominal thickness of the metal oxide coating is between 5 nm and 25 nm.

In some embodiments, the metal oxide coating includes a merged island morphology.

In some embodiments, the metal oxide coating includes a pure crystalline phase.

In another exemplary embodiment a battery cell includes an anode current collector, an anode active material layer in direct contact with a surface of the anode current collector, the anode active material layer including anode active materials, and, optionally, an anode binder, electrically conductive material, or both the anode binder and the electrically conductive material, a cathode current collector, a cathode active material layer in direct contact with a surface of the cathode current collector, the cathode active material including cathode active materials having a metal oxide coating, and, optionally, a cathode binder, electrically conductive material, or both the cathode binder and the electrically conductive material, and a separator positioned between the anode active material layer and the cathode active material layer. The metal oxide coating is electrochemically deposited onto the cathode active materials.

In some embodiments, the metal oxide coating is of the form MO₂, where M is titanium, manganese, aluminum, zirconium, zinc, copper, or magnesium.

In some embodiments, the metal oxide coating is TiO₂.

In some embodiments, a surface of the metal oxide coating includes a thickness variation of between 5 nm and 10 nm. In some embodiments, a nominal thickness of the metal oxide coating is between 5 nm and 25 nm.

In some embodiments, the metal oxide coating includes a merged island morphology.

In some embodiments, the metal oxide coating includes a pure crystalline phase.

In yet another exemplary embodiment a method can include forming an anode current collector, forming an anode active material layer in direct contact with a surface of the anode current collector, the anode active material layer including anode active materials, and, optionally, an anode binder, electrically conductive material, or both the anode binder and the electrically conductive material, forming a cathode current collector, forming a cathode active material layer in direct contact with a surface of the cathode current collector, the cathode active material layer including cathode active materials having a metal oxide coating, and, optionally, a cathode binder, electrically conductive material, or both the cathode binder and the electrically conductive material, and forming a separator positioned between the anode active material layer and the cathode active material layer. The metal oxide coating is electrochemically deposited onto the cathode active material.

In some embodiments, the metal oxide coating is of the form MO₂, where M is titanium, manganese, aluminum, zirconium, zinc, copper, or magnesium.

In some embodiments, the metal oxide coating is TiO₂.

In some embodiments, a surface of the metal oxide coating includes a thickness variation of between 5 nm and 10 nm. In some embodiments, a nominal thickness of the metal oxide coating is between 5 nm and 25 nm.

In some embodiments, the metal oxide coating includes a merged island morphology.

In some embodiments, the metal oxide coating includes a pure crystalline phase.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example battery cell in accordance with one or more embodiments;

FIG. 3 is an electrochemical deposition system for coating a cathode active material with a metal oxide coating in accordance with one or more embodiments;

FIG. 4 is a manufacturing process for coating a cathode active material with a metal oxide coating in accordance with one or more embodiments;

FIG. 5. is a computer system according to one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

High-energy density cathode active materials (CAM), such as Ni-rich and Mn-rich CAM, show great promise as next-generation cathode materials for lithium-ion batteries. However, their practical application faces several challenges, including the initial irreversible capacity loss and poor cycling stability associated with these materials. Various techniques for surface coating electrode particles have been proven to enhance the performance of cathode active materials in lithium-ion batteries, resulting in batteries which offer less capacity loss and a longer cycling life. Unfortunately, while vapor deposition techniques such as atomic layer deposition (ALD) and chemical vapor deposition (CVD) can offer precise control over coating thickness, these processes are somewhat complex and are not easily scalable.

This disclosure introduces a wet chemistry-based method that is cost-effective and scalable for coating CAM with a metal oxide coating. Specifically, an electrochemical method is provided for forming and/or depositing a metal oxide (e.g., TiO₂) coating on the surface of cathode particles. Lithium-ion batteries manufactured using the wet chemistry-based methods described herein offer a number of advantages over prior batteries. For example, the wet chemistry-based methods described herein can be completed as room temperature processes, with precise control on the thickness of the coating layer afforded by controlling a charge transfer per unit time. In other words, instead of relying on relatively complex techniques like ALD and CVD, an aqueous and wet-chemistry-based electrochemical approach is described for the electrodeposition of the metal oxide coating (e.g., TiO₂) on the CAM surface.

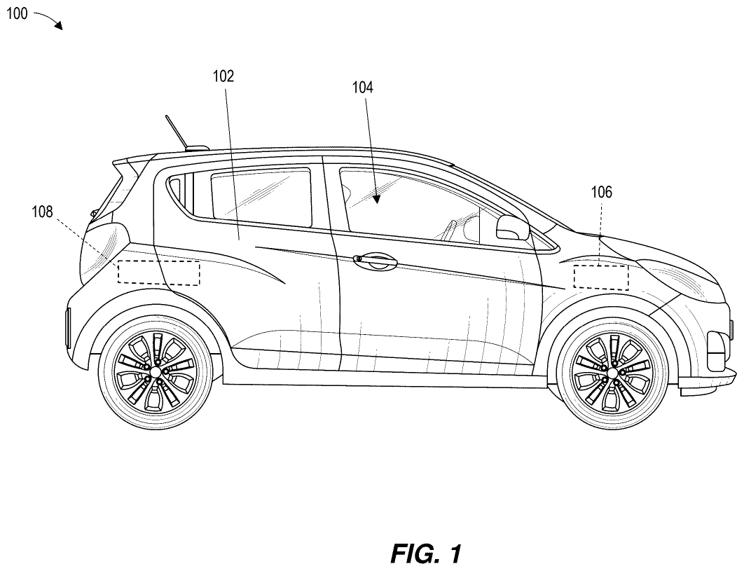

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

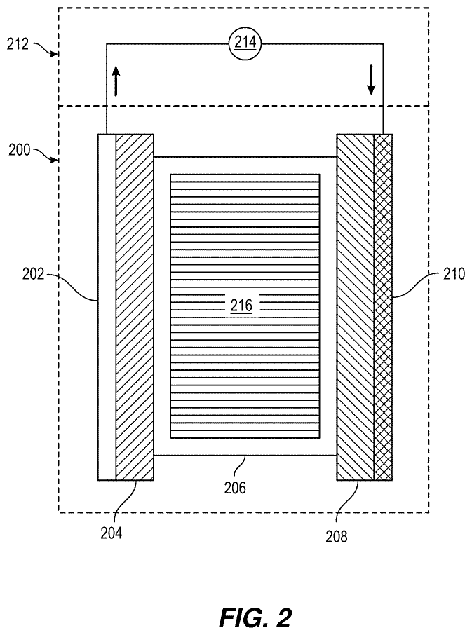

FIG. 2 illustrates an example battery cell 200 in accordance with one or more embodiments. The battery cell 200 can be incorporated as one of a number of battery cells in a battery pack (e.g., the battery pack 108 in FIG. 1). As shown in FIG. 2, the battery cell 200 includes an anode current collector 202, an anode active material layer 204, a separator 206, a cathode active material layer 208, and a cathode current collector 210, configured and arranged as shown.

The anode current collector 202 and the cathode current collector 210 respectively collect and move free electrons to and from an external circuit 212. In some embodiments, external circuit 212 includes a load device 214 (e.g., the electric motor 106 in FIG. 1). In some embodiments, external circuit 212 and load device 214 connect the anode active material layer 204 (through the anode current collector 202, also referred to as the negative electrode) and the cathode active material layer 208 (through the cathode current collector 210, also referred to as the positive electrode). The anode current collector 202 and the cathode current collector 210 can be made of sheets, foils (continuous or with punches or cuts), or mesh of conductive materials. For example, the cathode current collector 210 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 210 is made of aluminum foil. The anode current collector 202 can include, for example, copper foil and/or one or more graphene layers. In some embodiments, the anode current collector 202 is made of copper foil. The thickness of a current collector can be approximately 10 to 20 μm, although other thicknesses are within the contemplated scope of this disclosure.

The anode active material layer 204 is not meant to be particularly limited, and can include, for example, lithium metal, activated carbon powder, carbon based materials such as graphite, silicon, silicon-based materials such as LiₓSi, SiOₓ, LiSiOₓ, and nano-Si, silicon-graphite composites, tin, tin oxide (SnO₂), tin-cobalt alloys, lithium titanate (Li₄Ti₅O₁₂, LTO), metal alloys such as alloys of two or more of tin, germanium, and cobalt, and combinations thereof. The anode active material layer 204 can further include electrically conductive materials such as carbon black, graphene, and/or carbon nanotubes. The anode active material layer 204 can further include a binder material such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. The anode active material layer 204 can include, for example, greater than or equal to about 0 wt. % to less than or equal to about 20 wt. %, and in certain aspects, optionally greater than or equal to about 5 wt. % to less than or equal to about 15 wt. %, of one or more binders.

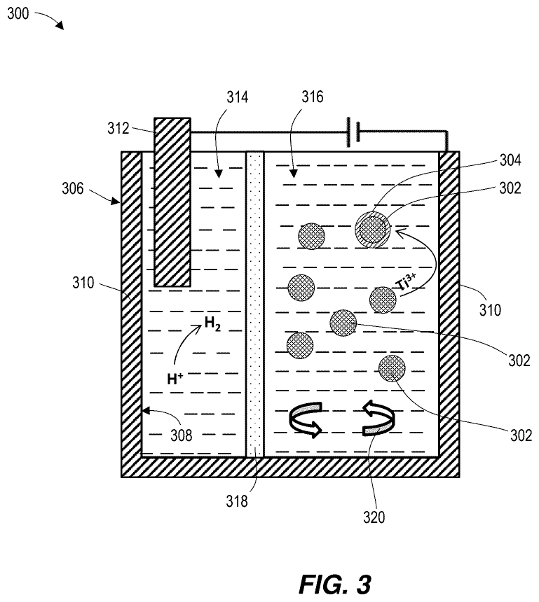

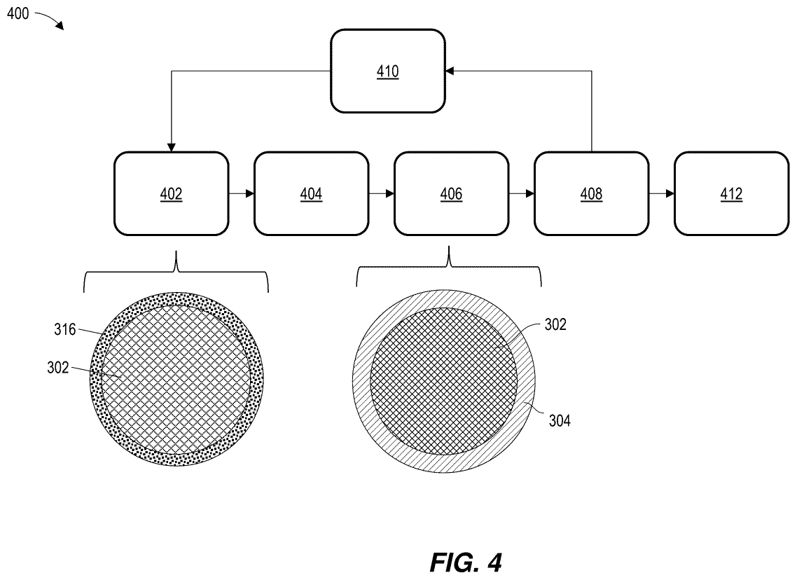

As will be described in greater detail with respect to FIGS. 3 and 4, the cathode active material layer 208 can include cathode active materials (e.g., cathode active material 302, refer to FIG. 3) coated with metal oxides (that is, CAM with metal oxide coatings). The cathode active material is not meant to be particularly limited, and can include, for example, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), lithium nickel manganese oxide (LNMO), and blends and combinations thereof. In some embodiments, the cathode active material includes materials having a negative electrode capacity to positive electrode capacity ratio (also referred to as the N to P ratio) of between 1 and 3. In some embodiments, the cathode active material layer 208 can include nickel manganese cobalt (NMC) variants, such as NMC 622, NMC 811, and NMC 532. In some embodiments, the cathode active material layer 208 can include nickel and manganese at mole ratios of 30:70 to 80:20, respectively. In some embodiments, the cathode active material layer 208 can further include Co in a range between 0 and 20 percent. The cathode active material layer 208 can further include a binder material in a similar manner as described with respect to the anode active material layer 204.

Depending on battery construction (e.g., conventional vs. bi-polar current collectors, etc.) the separator 206 is optional but, if included, can be positioned to isolate the anode active material layer 204 and the cathode active material layer 208. The separator 206 also provides a minimal resistance path for internal passage of lithium ions, and in certain instances, related anions, during cycling of the lithium ions. The separator 206 can include dielectric materials such as, for example, polyethylene (PE), polypropylene (PP), polyethylene terephthalate (PET), synthetic fluoropolymer such as polytetrafluoroethylene (PTFE), and composites thereof, although other dielectrics are within the contemplated scope of this disclosure. In some embodiments, the separator 206 may include a thermally stable coating layer to improve shrinkage behavior (e.g., a porous ceramic coating or porous ester type polymer coating including, for example, polyimide, polyamide, polyimide-polyamide (PI/PA) copolymer, etc.). The thickness of the separator 206 can be approximately 12 to 16 μm, although other thicknesses are within the contemplated scope of this disclosure.

As further shown in FIG. 2, the battery cell 200 includes an electrolyte 216. The electrolyte 216 can include a liquid electrolyte, a solid electrolyte, and/or a polymer electrolyte. In some embodiments, the electrolyte 216 is a liquid electrolyte that permeates, covers, penetrates, or partially penetrates the cathode active material layer 208, the separator 206, and/or the anode active material layer 204. In some embodiments, electrolyte 216 includes a lithium salt dissolved in a solvent, although other liquid electrolytes are possible and all such configurations are within the contemplated scope of this disclosure. The lithium salt chosen in the electrolyte 216 is not meant to be particularly limited and can vary depending on the needs of a given application. In some embodiments, for example, the lithium salt includes lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte 216 will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of the SEI layer on the lithium metal anode. In some embodiments, the lithium salts can be formed to a concentration of 0.1 M to 2 M, for example, 0.8 M, although other concentrations are within the contemplated scope of this disclosure.

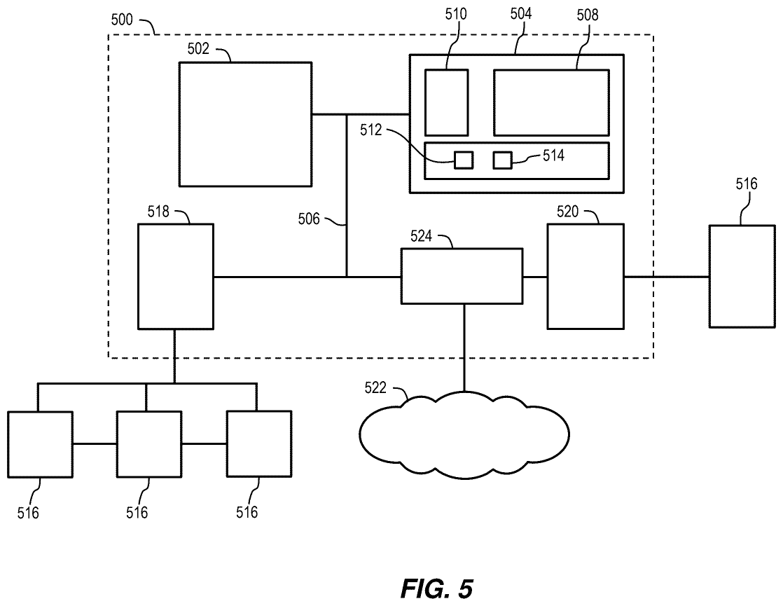

FIG. 3 illustrates an electrochemical deposition system 300 for coating a cathode active material 302 with a metal oxide coating 304 in accordance with one or more embodiments. As shown in FIG. 3, the electrochemical deposition system 300 can include vessel 306. In some embodiments, a conductive inner surface 308 of vessel 306 serves as an anode 310. In some embodiments, the anode 310 is electrically coupled to a cathode 312 positioned in vessel 306. In some embodiments, vessel 306 is filled with a solution 314 and a solution 316 separated by an ion-exchange membrane 318. In some embodiments, the vessel 306 can include a mixer 320 (or agitator, etc.) within solution 316. In some embodiments, a speed of the mixer 320 can be controlled (refer to FIG. 5) to increase contact between the cathode active material 302 and the anode 310.

In some embodiments, solution 314 includes an aqueous solution of HCl(aq). In some embodiments, solution 314 is a reducing solution in which hydrogen atoms (H+, protons) reduce at cathode 312, thereby forming molecular hydrogen (h₂).

In some embodiments, solution 316 includes an aqueous solution of a metal chloride (MClₓ) and HCl(aq), where M is titanium, manganese, aluminum, zirconium, zinc, copper, magnesium, etc., and x is 1, 2, 3, or 4. For example, solution 316 can include an aqueous solution of TiCl₃/HCl(aq). Other chemistries include, for example, MnCl₃, AlCl₃, ZrCl₃, CuCl₃, and MgCl₃. Solution 316 further includes cathode active material 302 dispersed throughout. In some embodiments, solution 316 is an oxidizing solution in which the cathode active material 302 can become coated with metal oxide coating 304 due to oxidation of metal ions (e.g., Ti³⁺ when M is Ti, Mg³⁺ when M is Mg, etc.) at the anode 310 (at the conductive inner surface 308). In some embodiments, oxygen in the cathode active material 302 reacts with the metal ions during this process, thereby depositing metal oxide (MO₂) on the cathode active material 302, where M is titanium, manganese, aluminum, zirconium, zinc, copper, magnesium, etc., as discussed previously. In other words, metal M from the metal chloride (MClₓ) can be electrochemically deposited as a metal oxide onto the cathode active material 302 via the transfer of metal ions (e.g., Ti³⁺).

Coating the cathode active material 302 with metal oxide coating 304 in this manner offers a number of advantages over prior processes. In particular, cathode active material 302 can be progressively coated with the metal oxide coating 304 over time, due to random collisions between the cathode active material 302 and the anode 310, without requiring relatively complex vapor deposition techniques such as ALD and CVD. Moreover, cathode active material 302 coated with metal oxide coating 304 using the electrochemical deposition system 300 previously described results in physical differences over cathode active materials coated with metal oxides using vapor deposition techniques. To illustrate, consider an example scenario in which CAM is coated with TiO₂ as described previously. The cathode active material 302 particle size can range from 1 to 10 microns, and the metal oxide coating 304 can be formed to a nominal (average) thickness of between 1 and 25 nm, or 5 and 25 nm (allowing for a 5 nm thickness variation as described in greater detail below).

However, in contrast to metal oxide coatings formed using vapor deposition techniques, the metal oxide coating 304 will have a varying thickness, distinct morphology, and pure crystalline structure. In particular, the metal oxide coating 304 will have a thickness variation of between 5 nm and 10 nm, while vapor deposition techniques result in coatings having a thickness variation of between 1 and 3 nm. In other words, the electrochemical deposition system 300 results in a metal oxide coating 304 having a relatively higher thickness variation than that provided using vapor deposition techniques (e.g., nearly double to more than a 300 percent increase in thickness variation). Moreover, the metal oxide coating 304 will have a merged island morphology (also referred to as clumping) due to metal oxides being deposited at the collision surface between the cathode active material 302 and anode 310 (thus, this is a non-uniform deposition process). In contrast, vapor deposition techniques such as ALD and CVD result in a uniform, layer-by-layer deposition. Finally, the metal oxide coating 304 will have a 100 percent crystalline phase, as opposed to a crystalline phase of between 50 and 70 percent when using vapor deposition techniques such as ALD and CVD (with the balance being an amorphous phase). Thus, the varying thickness, distinct morphology, and pure crystalline structure of the metal oxide coating 304 described herein can serve as a sort of physical signature of the chemical deposition system 300 (and manufacturing process 400, refer to FIG. 4).

FIG. 4 illustrates a manufacturing process 400 for coating a cathode active material 302 with a metal oxide coating 304 in accordance with one or more embodiments. As shown in FIG. 4, the manufacturing process 400 includes step 402, step 404, step 406, step 408, step 410, and step 412, configured and arranged as shown.

In some embodiments, step 402 includes suspending cathode active material 302 (also referred to as electrode material particles) in an aqueous electrolyte solution (e.g., solution 316 of FIG. 3). In some embodiments, cathode active material 302 is suspended in solution 316 at a temperature between about 20 degrees Celsius and 80 degrees Celsius, although other temperatures are within the contemplated scope of this disclosure, subject only to the aqueous electrolyte limits of the solution 316 chosen in a given application (e.g., about 0 degrees Celsius to about 100 degrees Celsius for most electrolyte solutions).

In some embodiments, cathode active material 302 is dispersed in the solution 316 at a predetermined pH that is selected to target a predetermined metal oxide structure and/or phase in the resulting metal oxide coating 304. In some embodiments, cathode active material 302 is dispersed in the solution 316 at a predetermined pH of between 1 and 7, or more specifically, between 1 and 3, although it should be understood that the pH will vary according to the selection of the metal oxide coating 304.

In some embodiments, step 404 includes applying a current and/or voltage to the solution 316. In some embodiments, step 404 includes applying a current and/or voltage across the anode 310 and cathode 312 of the electrochemical deposition system 300 (refer to FIG. 3). The voltage, current, and/or current density will vary depending on the deposited material, the targeted deposition thickness, and the reactor (vessel) design. The voltage, current, and/or current density can be held steady, or varied, as desired, to control the nominal thickness of the metal oxide coating 304 deposited onto the cathode active material 302, with relatively increased voltage, current, and/or current densities resulting in relatively thicker coatings, and vice versa.

In some embodiments, step 406 includes maintaining the current and/or voltage for a predetermined time and/or or a time required to achieve a targeted thickness of the metal oxide coating 304. In some embodiments, samples are taken from the solution 316 and the thickness of the metal oxide coating 304 is determined empirically. In some embodiments, the thickness of the metal oxide coating 304 is estimated using prior empirically derived data (e.g., thickness vs. time vs. current profiles from previous processes).

In some embodiments, step 408 includes filtering out and rinsing the cathode active material 302 coated with the metal oxide coating 304. The cathode active material 302 coated with the metal oxide coating 304 can be physically and/or chemically filtered from the solution 316 as desired. In this manner, the cathode active material 302 coated with the metal oxide coating 304 can be separated from the solution 316, and electrode fabrication and cell assembly can proceed at step 412.

In some embodiments, step 410 includes re-cycling the solution 316 (once the cathode active material 302 coated with the metal oxide coating 304 is separated via step 408). In some embodiments, the filtered solution 316 can be returned to the electrochemical deposition system 300 (refer to FIG. 3).

In some embodiments, step 412 involves the fabrication of a battery cell using, in part, the cathode active material 302 coated with the metal oxide coating 304. Step 412 can include, for example, the fabrication and/or sourcing of current collectors, separators, electrolytes, etc. (refer to FIG. 2).

FIG. 5 illustrates aspects of an embodiment of a computer system 500 that can perform various aspects of embodiments described herein. In some embodiments, the computer system(s) 500 can implement and/or otherwise be incorporated within or in combination with electrochemical deposition system 300 (refer to FIG. 3) and/or manufacturing process 400 (refer to FIG. 4). For example, in some embodiments, computer system 500 can control a temperature, a pressure, a voltage, a current, a stirring rate, etc., of the electrochemical deposition system 300 during the manufacturing process 400.

The computer system 500 includes at least one processing device 502, which generally includes one or more processors or processing units for performing a variety of functions, such as, for example, any and/or all of the functions described with respect to FIG. 7. Components of the computer system 500 also include a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media. For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to any of the block diagrams described herein. The computer system 500 is not so limited, as other modules may be included depending on the desired functionality of the computer system 500. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 502 can also be configured to communicate with one or more external devices 516 such as, for example, a keyboard, a pointing device, and/or any devices (e.g., a network card, a modem, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

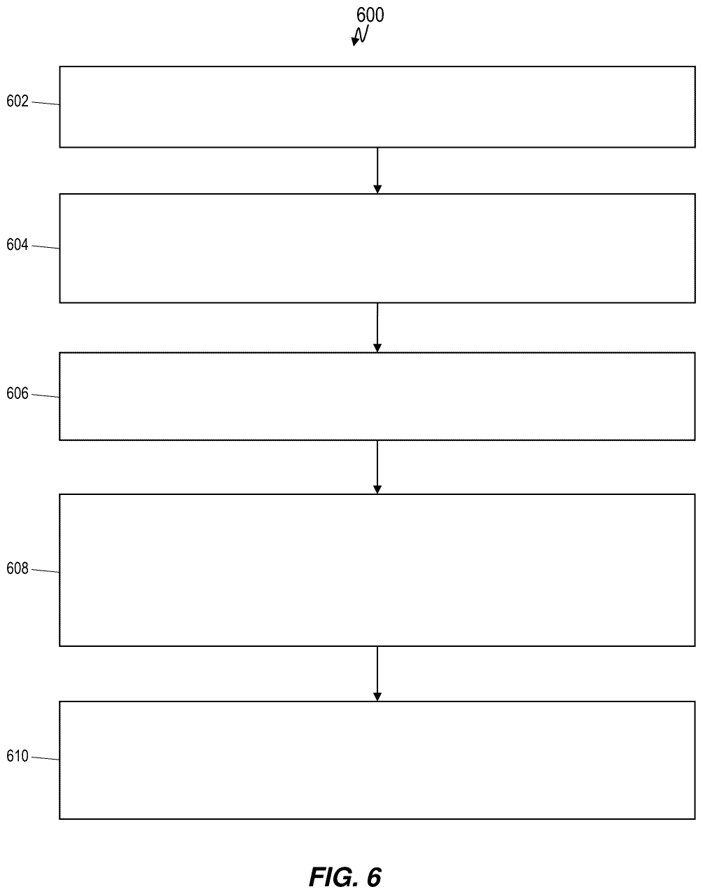

Referring now to FIG. 6, a flowchart 600 for the electrochemical deposition of a metal oxide coating on cathode active materials is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming an anode current collector.

At block 604, the method includes forming an anode active material layer in direct contact with a surface of the anode current collector. In some embodiments, the anode active material layer includes anode active materials, and, optionally, an anode binder, electrically conductive material, or both the anode binder and the electrically conductive material.

At block 606, the method includes forming a cathode current collector.

At block 608, the method includes forming a cathode active material layer in direct contact with a surface of the cathode current collector. In some embodiments, the cathode active material layer includes cathode active materials having a metal oxide coating, and, optionally, a cathode binder, electrically conductive material, or both the cathode binder and the electrically conductive material.

At block 610, the method includes forming a separator positioned between the anode active material layer and the cathode active material layer.

In some embodiments, the metal oxide coating is of the form MO₂, where M is titanium, manganese, aluminum, zirconium, zinc, copper, or magnesium.

In some embodiments, the metal oxide coating is TiO₂.

In some embodiments, a surface of the metal oxide coating includes a thickness variation of between 5 nm and 10 nm. In some embodiments, a nominal thickness of the metal oxide coating is between 5 nm and 25 nm.

In some embodiments, the metal oxide coating includes a merged island morphology.

In some embodiments, the metal oxide coating includes a pure crystalline phase.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
an anode current collector;
an anode active material layer in direct contact with a surface of the anode current collector, the anode active material layer comprising anode active materials, and, optionally, an anode binder, electrically conductive material, or both the anode binder and the electrically conductive material;
a cathode current collector;
a cathode active material layer in direct contact with a surface of the cathode current collector, the cathode active material layer comprising cathode active materials having a metal oxide coating, and, optionally, a cathode binder, electrically conductive material, or both the cathode binder and the electrically conductive material; and
a separator positioned between the anode active material layer and the cathode active material layer;
wherein the metal oxide coating is electrochemically deposited onto the cathode active materials.

2. The vehicle of claim 1, wherein the metal oxide coating is of the form MO₂, where M is titanium, manganese, aluminum, zirconium, zinc, copper, or magnesium.

3. The vehicle of claim 2, wherein the metal oxide coating is TiO₂.

4. The vehicle of claim 1, wherein a surface of the metal oxide coating comprises a thickness variation of between 5 nm and 10 nm.

5. The vehicle of claim 4, wherein a nominal thickness of the metal oxide coating is between 5 nm and 25 nm.

6. The vehicle of claim 1, wherein the metal oxide coating comprises a merged island morphology.

7. The vehicle of claim 1, wherein the metal oxide coating comprises a pure crystalline phase.

8. A battery cell comprising:
an anode current collector;
an anode active material layer in direct contact with a surface of the anode current collector, the anode active material layer comprising anode active materials, and, optionally, an anode binder, electrically conductive material, or both the anode binder and the electrically conductive material;
a cathode current collector;
a cathode active material layer in direct contact with a surface of the cathode current collector, the cathode active material layer comprising cathode active materials having a metal oxide coating, and, optionally, a cathode binder, electrically conductive material, or both the cathode binder and the electrically conductive material; and
a separator positioned between the anode active material layer and the cathode active material layer;
wherein the metal oxide coating is electrochemically deposited onto the cathode active materials.

9. The battery cell of claim 8, wherein the metal oxide coating is of the form MO2, where M is titanium, manganese, aluminum, zirconium, zinc, copper, or magnesium.

10. The battery cell of claim 9, wherein the metal oxide coating is TiO2.

11. The battery cell of claim 8, wherein a surface of the metal oxide coating comprises a thickness variation of between 5 nm and 10 nm.

12. The battery cell of claim 11, wherein a nominal thickness of the metal oxide coating is between 5 nm and 25 nm.

13. The battery cell of claim 8, wherein the metal oxide coating comprises a merged island morphology.

14. The battery cell of claim 8, wherein the metal oxide coating comprises a pure crystalline phase.

15. A method comprising:
forming an anode current collector;
forming an anode active material layer in direct contact with a surface of the anode current collector, the anode active material layer comprising anode active materials, and, optionally, an anode binder, electrically conductive material, or both the anode binder and the electrically conductive material;
forming a cathode current collector;
forming a cathode active material layer in direct contact with a surface of the cathode current collector, the cathode active material layer comprising cathode active materials having a metal oxide coating, and, optionally, a cathode binder, electrically conductive material, or both the cathode binder and the electrically conductive material; and
forming a separator positioned between the anode active material layer and the cathode active material layer.

16. The method of claim 15, wherein the metal oxide coating is of the form MO2, where M is titanium, manganese, aluminum, zirconium, zinc, copper, or magnesium.

17. The method of claim 16, wherein the metal oxide coating is TiO2.

18. The method of claim 15, wherein a surface of the metal oxide coating comprises a thickness variation of between 5 nm and 10 nm.

19. The method of claim 18, wherein a nominal thickness of the metal oxide coating is between 5 nm and 25 nm.

20. The method of claim 15, wherein the metal oxide coating comprises a merged island morphology and a pure crystalline phase.
